(19) United States
(12) Patent Application Publication
(10) Pub. No.: US 2024/0063467 A1
(43) Pub. Date: Feb. 22, 2024

(54) TRACTION BATTERY PACK ROUTABLE COMPONENT SUPPORTING ASSEMBLY AND SUPPORTING METHOD

(71) Applicant: Ford Global Technologies, LLC, Dearborn, MI (US)

(72) Inventors: Ira Jason Goldberg, Ann Arbor, MI (US); Nicholas Braeseker, Novi, MI (US); Terri Turmell, White Lake, MI (US); Chris David Tiernan, Commerce Township, MI (US)

(21) Appl. No.: 17/892,429

(22) Filed: Aug. 22, 2022

(51) Int. Cl. H01M 10/6555; H01M 10/613; H01M 10/625

(52) U.S. Cl. CPC H01M 10/6555; H01M 10/613; H01M 10/625; H01M 2220/20

(57) ABSTRACT

A battery pack system includes first and second battery arrays of a traction battery pack and a thermal barrier assembly disposed at least partially between the first and second battery arrays. The thermal barrier assembly is configured to block thermal energy movement from the first battery array to the second battery array, and from the second battery array to the first battery array. The thermal barrier assembly includes a primary attachment portion, a first lip that interfaces with the first array, and a second lip that interfaces with the second array. The system further includes a routable component of the traction battery pack. The routable component is received within a channel of the first lip and a channel of the second lip.

### TECHNICAL FIELD

This disclosure relates generally to thermal barrier of a traction battery pack and to supporting components of the traction battery pack using the thermal barriers.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells arranged in arrays.

### SUMMARY

In some aspects, the techniques described herein relate to a battery pack system, including: first and second battery arrays of a traction battery pack; a thermal barrier assembly disposed at least partially between the first and second battery arrays, the thermal barrier assembly configured to block thermal energy movement from the first battery array to the second battery array, and from the second battery array to the first battery array, the thermal barrier assembly including a primary attachment portion, a first lip that interfaces with the first array, and a second lip that interfaces with the second array; and a routable component of the traction battery pack, the routable component received within a channel of the first lip and a channel of the second lip.

In some aspects, the techniques described herein relate to a system, wherein the first lip and the second lip extend vertically upward from the primary attachment portion.

In some aspects, the techniques described herein relate to a system, further including a cross-member disposed between the first and second battery arrays, the thermal barrier assembly secured directly to the cross-member.

In some aspects, the techniques described herein relate to a system, further including a plurality of mechanical fasteners that secure the cross-member directly to cross-member.

In some aspects, the techniques described herein relate to a system, wherein at least a portion of the first array is sandwiched between the first lip and a surface of a battery pack enclosure, wherein at least a portion of the second array is sandwiched between the second lip and the surface of the battery pack enclosure.

In some aspects, the techniques described herein relate to a system, wherein the first and second battery arrays each include a plurality of battery cells disposed along a respective battery array axis, wherein a longitudinal axis of the thermal barrier assembly is parallel to the battery array axis of the first array and parallel to the battery array axis of the second array.

In some aspects, the techniques described herein relate to a system, wherein the routable component spans over the primary attachment portion.

In some aspects, the techniques described herein relate to a system, further including a cover of the traction battery pack, the routable component sandwiched between the cover and the thermal barrier assembly.

In some aspects, the techniques described herein relate to a system, further including a plurality of mechanical fasteners that extend through the thermal barrier assembly to secure the cover to a cross-member of the battery pack.

In some aspects, the techniques described herein relate to a system, wherein the routable component is a coolant hose.

In some aspects, the techniques described herein relate to a system, wherein the routable component is a busbar.

In some aspects, the techniques described herein relate to a system, wherein the routable component is a component of an electrical distribution system of the traction battery pack.

In some aspects, the techniques described herein relate to a system, wherein the thermal barrier assembly is a polymer-based material.

In some aspects, the techniques described herein relate to a battery pack component supporting method, including: positioning a thermal barrier assembly between first and second arrays of a traction battery pack such that a first lip of the thermal barrier assembly interfaces with the first array and a second lip of the thermal barrier assembly interfaces with the second array; and holding a routable component of the traction battery pack within a channel of the first lip and a channel of the second lip.

In some aspects, the techniques described herein relate to a method, wherein the first lip and the second lip extend upward from a primary portion of the thermal barrier assembly.

In some aspects, the techniques described herein relate to a method, wherein the routable component spans over the primary portion.

In some aspects, the techniques described herein relate to a method, further including compartmentalizing the first and second arrays within the battery pack using the thermal barrier assembly.

In some aspects, the techniques described herein relate to a method, further including attaching the thermal barrier assembly to a cross-member of the traction battery pack.

In some aspects, the techniques described herein relate to a method, attaching a cover to the cross-member using fasteners that extend through respective bores in the thermal barrier assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle have a traction battery pack.

FIG. 2 illustrates an expanded perspective view of selected portions of the traction battery pack of FIG. 1.

FIG. 3 illustrates a perspective view of the thermal barrier assembly and cross-member from the traction battery pack of FIG. 2.

FIG. 4 illustrates a close-up view of an area of FIG. 2.

FIG. 5 illustrates a section view taken at line 5-5 in FIG. 3.

FIG. 6 illustrates a perspective view of the thermal barrier assembly providing a mounting location for a module.

### DETAILED DESCRIPTION

This disclosure details thermal barrier assemblies for a traction battery pack. The thermal barrier assemblies can be rated for thermal propagation events. The thermal barriers can be, for example, positioned between adjacent battery arrays to compartmentalize the traction battery pack, and can be secured to battery tray crossmembers so as to extend above a height of the battery arrays. The separators can include features such as lips that rest line-to-line with the arrays to seal and provide a barrier between the arrays, integrated channels for routing and retaining routable components (e.g., wires, busbars, coolant hoses, modules, etc.), and integrated compression limiters for use when securing an enclosure cover.

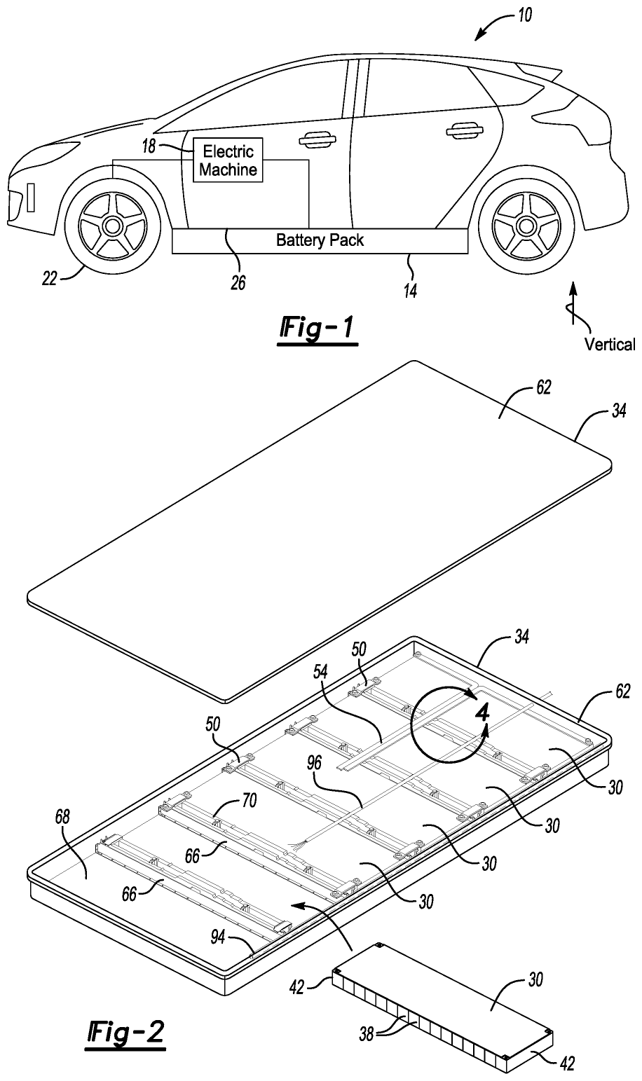

With reference to FIG. 1, an electrified vehicle 10 includes a traction battery pack 14, an electric machine 18, and wheels 22. The battery pack 14 powers an electric machine 18, which converts electric power to torque to drive the wheels 22. The battery pack 14 can be a relatively high-voltage battery.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead, or in addition to, an electric machine. Generally, the electrified vehicle 10 could be any type of vehicle having a traction battery pack.

Referring now to FIG. 2 with continuing reference to FIG. 1, the battery pack 14 includes a plurality of battery arrays 30 housed in an enclosure 34. The battery arrays 30 are groups of individual battery cells 38 arranged in a rows. In an embodiment, the battery cells 38 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

In this example, the battery cells 38 of the arrays 30 are disposed along a respective axis of the battery array 30 and are compressed between the endplates 42. The arrays 30 each further include a top plate 46 that extends over the vertically upper surfaces of the battery cells 38. Vertical, for purposes of this disclosure is with reference to ground and a general orientation of the vehicle 10 during operation.

Various busbars 50 are incorporated into the battery pack 14. The busbars 50 electrically connect one of the arrays 30 to another of the arrays 30. The battery pack 14 can include other busbars 54 that electrically connect one or more of the arrays 30 to a device other than an array 30, such as a device that electrically couples the battery pack 14 to another part of the electrified vehicle 10.

The enclosure 34 includes a tray 58 and a cover 62. The tray 58 can be stamped from a sheet metal blank in some examples.

A plurality of cross-members 66 are positioned within the tray 58. The cross-members 66 can be secured to a floor 68 of the tray 58 using welds or mechanical fasteners. One of the cross-members 66 is disposed between each of arrays 30 in this example. The cross-members 66 extend in a cross-vehicle direction. The longitudinal axis of the cross-members 66 is, in this example, parallel to the axes of the battery arrays 30 within the battery pack 14. The cross-members 66 can strengthen the battery pack 14.

Atop at least some of the cross-members 66 are thermal barrier assemblies 70. Together with the cross-members 66, the thermal barrier assemblies 70 divide an interior of the battery pack 14 into various compartments. Each compartment houses one of the battery arrays 30. Should, for example, a thermal event occur in one of the battery arrays 30, the thermal barrier assemblies 70 can help to block thermal energy associated with the thermal event from moving to other battery arrays 30 and thereby inhibit a thermal runaway event.

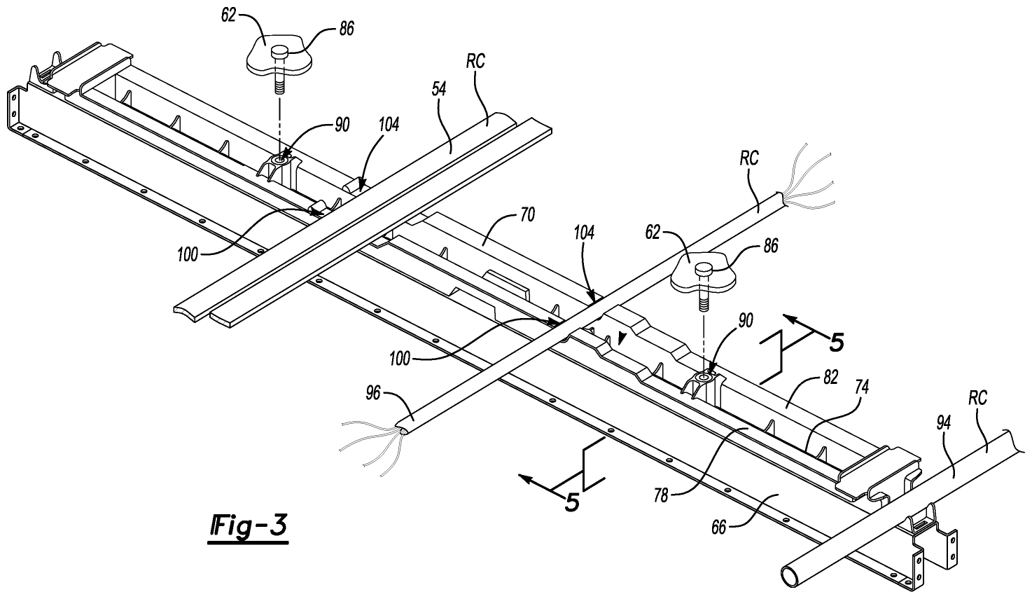

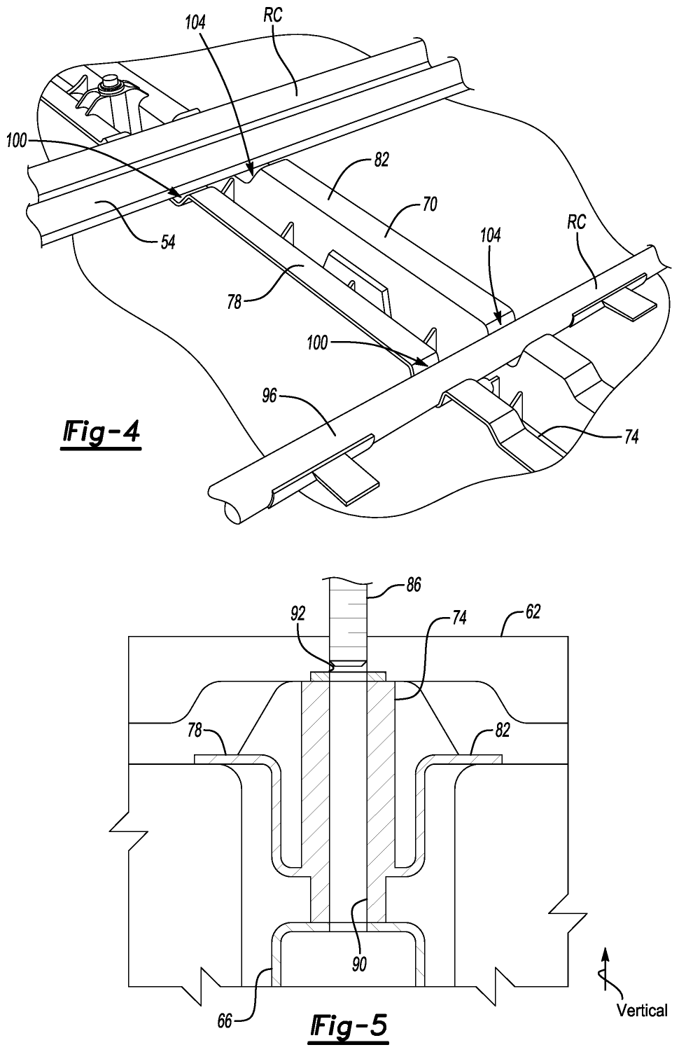

With reference now to FIGS. 3-5 and continued reference to FIG. 2, the thermal barrier assemblies 70 each include a primary attachment portion 74, a first lip 78, and a second lip 82. When installed, the primary attachment portion 74 interfaces directly with, and attaches directly to, one of the cross-members 66. The first lip 78 and the second lip 82 extend upward and outward from the primary attachment portion 74. When installed, the first lip 78 extends along a vertically upper side of one of the arrays 30 on a first side of the thermal barrier assembly 70, and the second lip 82 extends along a vertically upper side of another of the arrays 30 that is on a second side of the thermal barrier assembly 70.

The thermal barrier assembly 70 each attach to a respective cross-member 66 via at least one mechanical fastener 86. Securing the fasteners 86 draws the first lip 78 and the second lip 82 downward to sandwich the arrays 30 against the floor 68, which seals the lips 78 and 82 against the respective arrays 30 and helps to secure and retain the respective arrays 30 within the enclosure 34. In some examples, compressible features can be disposed between the lips 78 and 82 and the respective arrays 30. The compressible feature can be a foam or a rubber overmolding, for example. The compressible feature can help to seal the interfaces between the lips 78 and 82 and the respective arrays 30.

Each of the fasteners 86 can extend through a bore 90 in the primary attachment portion 74 of the thermal barrier assembly 70 to threadably engage the cross-member 66. In this example the fasteners 86 additionally extend through a bore 92 in the cover 62. The fasteners 86 then secure the cover 62 and the thermal barrier assemblies 70 to the cross-member 66. Separate fasteners to attach the thermal barrier assemblies 70 are not required.

In addition to blocking movement of thermal energy between the arrays 30, the thermal barrier assemblies 70 additionally help to align and support routable components “RC” of the traction battery pack 14. Example routable components RC can include the busbars 50, 54, a coolant hose 94, and components 96 of an electrical distribution system, such as a wire harness. The thermal barrier assemblies 70 are configured to retain various components including in the battery pack 14.

In particular, the first lip 78 includes channels 100 and the second lip 82 includes channel 104. The routable components RC are each received within one of the channels 100 of the first lip 78 and within one of the channels 104 of the second lip 82. In this example, when positioned within the channels 100, 104, the routable component RC spans over the primary attachment portion 74 such that there is a gap G between the routable component RC and the primary attachment portion 74.

With the routable components RC held within the channels 100, 104, the cover 62 can be secured to the tray 58 such that the routable component RC is sandwiched between the cover 62 and the thermal barrier assembly 70. The channels 100, 104 help to ensure that the routable component RC remains positioned when the cover 62 is secured. The channels 100, 104 each interface with three sides of the routable components RC.

In some examples, attachment features can be molded directly into the thermal barrier assemblies 70 to allow for the direct mounting of modules. Molding attachments into the barrier itself can reduce or eliminate the need for a bridging bracket and can reduce build complexity.

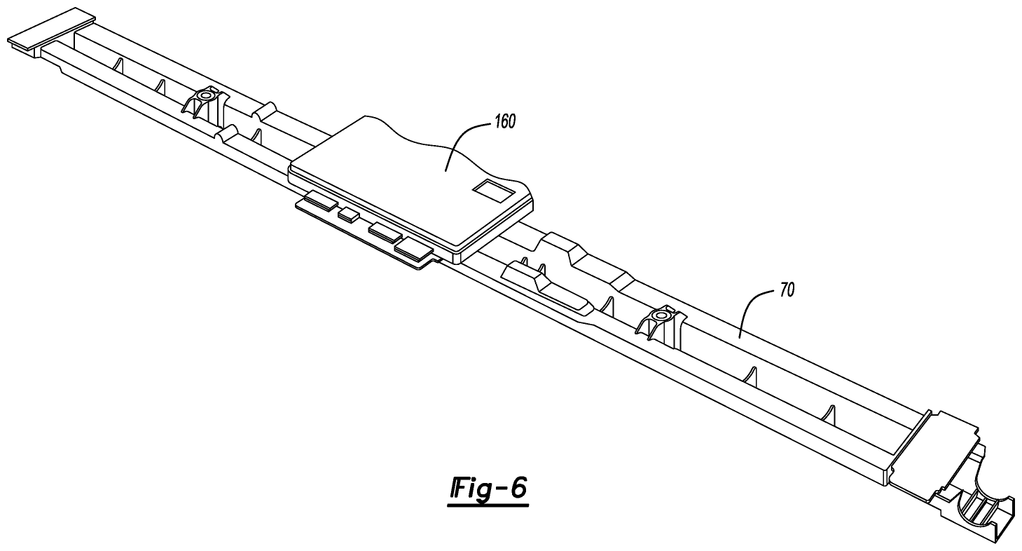

For example, referring to FIG. 6, the thermal barrier assembly 70 can, in some examples, provide an attachment location for a module 160, or another rigid component such as a sensor. The module 160 can be secured using attachment features that are at least partially molded into the thermal barrier assembly 70. The attachment features can include mechanical features along with blind holes provided in the thermal barrier assembly 70.

Supporting rigid components like the modules 160 with the thermal barrier assembly 70 can shield these components against thermal energy without adding direct shielding or barriers to the components themselves. Separate mounting brackets are also not required, as the attachments can be integrated into the thermal barrier assembly 70.

The thermal barrier assemblies 70 are polymer-based structure in this example. The thermal barrier assemblies 70 can each be molded as a singular piece.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack system, comprising:
first and second battery arrays of a traction battery pack;
a thermal barrier assembly disposed at least partially between the first and second battery arrays, the thermal barrier assembly configured to block thermal energy movement from the first battery array to the second battery array, and from the second battery array to the first battery array, the thermal barrier assembly including a primary attachment portion, a first lip that interfaces with the first array, and a second lip that interfaces with the second array; and
a routable component of the traction battery pack, the routable component received within a channel of the first lip and a channel of the second lip.

2. The system of claim 1, wherein the first lip and the second lip extend vertically upward from the primary attachment portion.

3. The system of claim 1, further comprising a cross-member disposed between the first and second battery arrays, the thermal barrier assembly secured directly to the cross-member.

4. The system of claim 3, further comprising a plurality of mechanical fasteners that secure the cross-member directly to cross-member.

5. The system of claim 1, wherein at least a portion of the first array is sandwiched between the first lip and a surface of a battery pack enclosure, wherein at least a portion of the second array is sandwiched between the second lip and the surface of the battery pack enclosure.

6. The system of claim 1, wherein the first and second battery arrays each include a plurality of battery cells disposed along a respective battery array axis, wherein a longitudinal axis of the thermal barrier assembly is parallel to the battery array axis of the first array and parallel to the battery array axis of the second array.

7. The system of claim 1, wherein the routable component spans over the primary attachment portion.

8. The system of claim 1, further comprising a cover of the traction battery pack, the routable component sandwiched between the cover and the thermal barrier assembly.

9. The system of claim 8, further comprising a plurality of mechanical fasteners that extend through the thermal barrier assembly to secure the cover to a cross-member of the battery pack.

10. The system of claim 1, wherein the routable component is a coolant hose.

11. The system of claim 1, wherein the routable component is a busbar.

12. The system of claim 1, wherein the routable component is a component of an electrical distribution system of the traction battery pack.

13. The system of claim 1, wherein the thermal barrier assembly is a polymer-based material.

14. A battery pack component supporting method, comprising:
positioning a thermal barrier assembly between first and second arrays of a traction battery pack such that a first lip of the thermal barrier assembly interfaces with the first array and a second lip of the thermal barrier assembly interfaces with the second array; and
holding a routable component of the traction battery pack within a channel of the first lip and a channel of the second lip.

15. The method of claim 14, wherein the first lip and the second lip extend upward from a primary portion of the thermal barrier assembly.

16. The method of claim 15, wherein the routable component spans over the primary portion.

17. The method of claim 14, further comprising compartmentalizing the first and second arrays within the battery pack using the thermal barrier assembly.

18. The method of claim 14, further comprising attaching the thermal barrier assembly to a cross-member of the traction battery pack.

19. The method of claim 18, attaching a cover to the cross-member using fasteners that extend through respective bores in the thermal barrier assembly.
